(19) United States
(12) Patent Application Publication
(10) Pub. No.: US 2008/0103006 A1
(43) Pub. Date: May 1, 2008

(54) HYDROMECHANICAL TRANSMISSION WITH INPUT SUMMER

(75) Inventors: Frederic W. Pollman, Eden Prairie, MN (US); Wilhelm Gollner, Neumunster (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/737,853

(22) Filed: Apr. 20, 2007

Related U.S. Application Data
(60) Provisional application No. 60/863,499, filed on Oct. 30, 2006.

(51) Int. Cl. F16H 47/04

(52) U.S. Cl. 475/72

(57) ABSTRACT

A hydromechanical transmission that has first and second planetaries each having first, second and third elements. The first element of the first planetary is connected to a first hydrostatic unit while the second element of the first planetary is connected to a second hydrostatic unit with the third element of the first planetary connected to an input. A primary clutch is connected between first and third elements of the second planetary while at least one secondary clutch is connected to the second planetary. When the primary and secondary clutches are selectively engaged at least two operating modes having continuous ratios are provided.

### CROSS REFERENCE TO RELATED APPLICATION

This application claims the benefit of U.S. Provisional Application No. 60/863,499 filed Nov. 30, 2006.

### BACKGROUND OF THE INVENTION

There are a number of work vehicles that desire to have continuous ratio transmissions with high efficiency for maximum power delivery to the wheels and for high fuel economy. These include tractors, loaders, utility vehicles and trucks. These vehicles also have requirements for low cost and good controllability throughout the entire speed range. This disclosure identifies a split power hydro-mechanical transmission that accommodates a range of these vehicle needs in a compact and flexible package.

Two transmissions are disclosed that vary the number of modes, including either two forward modes or three forward modes, and both versions have one reverse mode. The disclosed transmissions provide a continuous ratio from full reverse to full forward speed, eliminating the need for any clutch between the engine and transmission. The three mode transmission is a derivative of the two mode and as such may be designed to be configured with the same housing and hydrostatic units. The two mode transmission has an alternate configuration that allows reverse speed to have a flexible maximum value.

In the present transmissions, all modes are hydromechanical and have a split power flow in an input summer configuration. The speed for both mode 1 forward and reverse mode start at zero speed and are continuously increasing in speed until the limit of the hydrostatic units is reached. This allows continuous cycling forward to reverse while maintaining continuous speed and torque control. As mode 1 forward and reverse mode are separate hydromechanical modes, maximum torque in reverse need not be the same as maximum torque in forward.

The transmission schemes have a low number of gears and the minimum number of clutches, one of which is may be a brake. The clutch and gearing scheme utilizes two or three planetaries, depending of the number of modes. The planetaries operate in conjunction with each other to allow a continuous ratio with the hydrostatic units not going over center (to reverse displacement), and without having recirculating power. One of the planetaries is always power splitting and is continuously connected to the two hydrostatic units and the input. The second can be bypassed, used as a gear reducer and reverser, or in a power splitting manner in combination with the first planetary. The third planetary, if used, is power splitting in combination with the first planetary.

Hydromechanical transmissions are characterized by a hydrostatic transmission power path in parallel with a mechanical power transmission path, arranged in a manner to decrease the average power flow through the hydrostatic portion and thereby increase operating efficiency. Typically, the mechanical power path includes a planetary gear set which acts to sum the power flows at either the input or output end of the transmission.

The existence of parallel power paths creates the possibility of reducing the output speed range or torque ratio in order to further reduce transmitted hydrostatic power; this then requires multiple ranges or “modes” to achieve the full torque and speed range of the transmission. The impact of multiple modes is to improve efficiency and sometimes to reduce cost. In addition to efficiency and cost, the magnitude of the output speed range/torque ratio in each mode has an impact on input power capacity relative to the size of the HST. Smaller ratios allow larger input power for the same size hydrostatic units. It is obvious that more modes allow either smaller mode ratios or larger transmission ratios or both. These relationships create the possibility for having a versatile design configuration that accommodates a number of market needs for input power, ratio range and efficiency.

Multi-mode HMT's are usually accomplished by reusing the hydrostatic components and clutching to a different mechanical component. The mechanical component will be a planetary if the mode is hydromechanical. Usually the modes are arranged so that there is no ratio change during the mode change in order to have continuous speed or torque delivery.

Therefore, it is a principle object of the present invention to provide a multimode HMT that improves output power of the HMT.

Yet another object of the present invention is to provide a multimode HMT that improves overall operation of the hydromechanical transmission.

These and other objects, features, or advantages of the present invention will become apparent from the specification and the claims.

### BRIEF SUMMARY OF THE INVENTION

A hydromechanical transmission having a first planetary with a first hydrostatic unit connected to a first element at and a second hydrostatic unit connected to a second element and an input connected to a third element. The transmission additionally has a second planetary having first, second and third elements wherein a primary clutch is connected between the first and third elements of the second planetary. Additionally, there is at least one secondary clutch connected to the second planetary and when the primary and secondary clutches are selectively engaged at least two operating modes having continuous ratios are provided.

### BRIEF DESCRIPTION OF THE DRAWINGS

FIG. 1 is a block diagram of a hydromechanical transmission;

FIG. 2 is a speed diagram of a hydromechanical transmission

FIG. 3 is a schematic diagram of a hydromechanical transmission;

FIG. 4 is a block diagram of a hydromechanical transmission;

FIG. 5 is a speed diagram of a hydromechanical transmission;

FIG. 6 is a schematic diagram of a hydromechanical transmission;

FIG. 7 is a block diagram of a hydromechanical transmission;

FIG. 8 is a speed diagram of a hydromechanical transmission; and

FIG. 9 is a schematic diagram of a hydromechanical transmission.

### DESCRIPTION OF THE PREFERRED EMBODIMENT

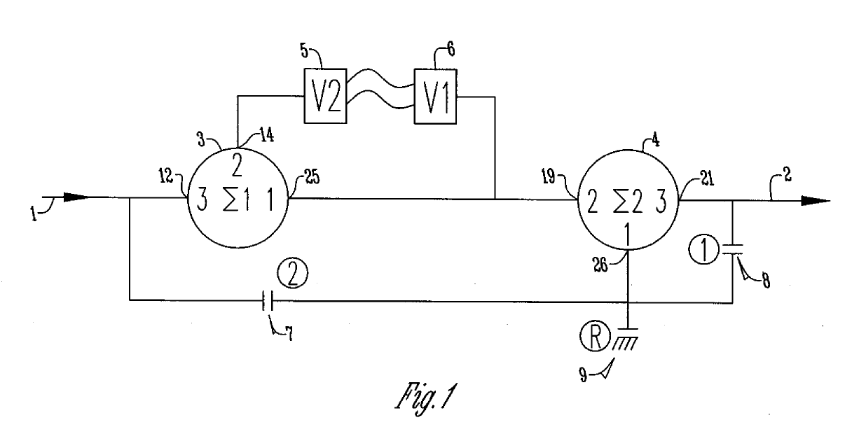

FIG. 1 shows a block diagram of a two forward mode HMT. Summers 3 and 4 are gear planetaries and each has three elements. There are two variable displacement hydrostatic units 5 and 6. Three clutches 7, 8 and 9 vary the connections of summer 4 to output 2, to summer 3 or to ground. A controller regulates the displacement of units 5 and 6 and operates the clutches to achieve the desired transmission ratio and engine power delivery.

Input 1 is connected to summer element 12 of planetary 3 and output 2 is connected to element 21 of planetary 4. Unit 5 is connected to summer element 14 and unit 6 is connected elements 25 and 19. In mode 1, clutch 8 connects output 2 to summer element 26 which locks up planetary 4. In mode 2, clutch 7 connects summer element 26 to input 1, creating a four-element planetary 3/4. Because clutch 8 locks up planetary 4, it can be connected between any two of planetary 4 elements. In reverse, element 26 is connected to a ground which prevents rotation of element 26. Planetary 3 and 3/4 are input summers as the input 1 is not connected to either variable unit 5 or 6, and is connected to one element of summer 3.

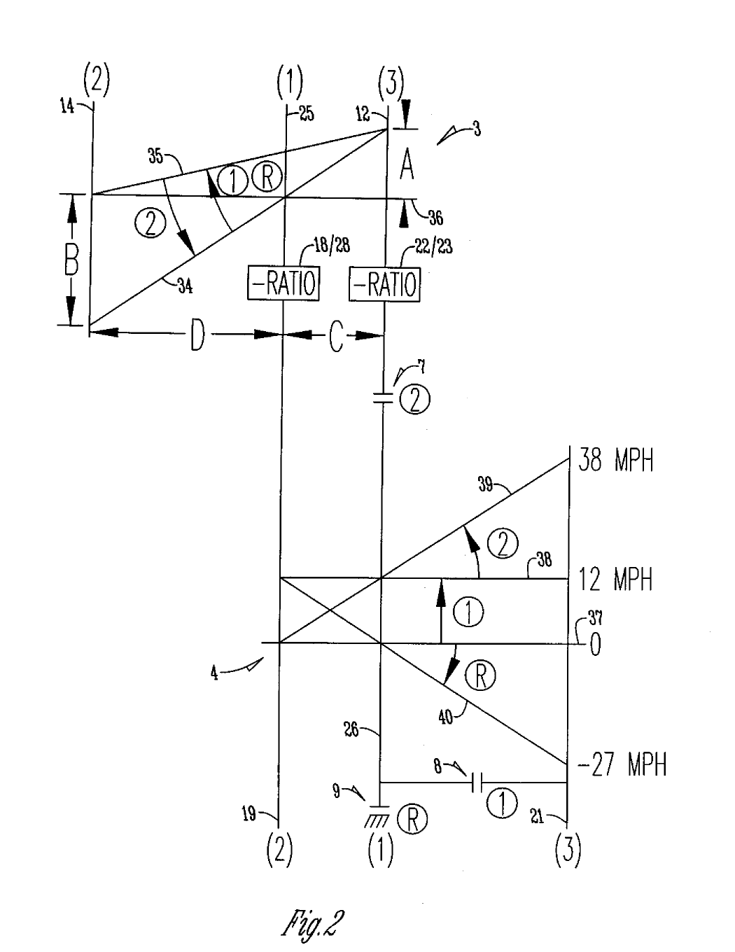

FIG. 2 is a speed diagram for planetaries 3 and 4. A speed diagram is a graphical illustration of the speed relationships for all the elements of a planetary, and it is the basis for both the transmission block diagram and the gear and clutch schematic. In FIG. 2, the vertical axes 14, 25 and 12 represent speed of the elements of planetary 3 and the horizontal axis 36 is planetary ratio. The length between the vertical axis lines represents the ratio of the planetary gears. By example, if axis 12 is a ring gear, axis 25 a carrier, and axis 14 a sun, then the ratio D/C represents the ratio of ring teeth to sun teeth. If the speed of element 25 was zero, and the ratio D/C was −2, the ratio B/A would be −2 as shown with line 34. Thus sun speed would be twice ring speed and in the opposite direction.

This speed diagram is enhanced with the locations of clutches and interplanetary gear ratios. A negative ratio indicates that the relative direction of rotation for the planetaries is opposite. The speed diagrams are all shown with the output speed positive for forward direction even though the actual direction of rotation will be opposite for a negative gear ratio.

Vertical axes 19, 26 and 21 are elements of planetary 4. There is a negative ratio 22/23 between elements 12 and 26 and negative ratio 18/28 between elements 25 and 19. Mode 1 starts with clutch 8 engaged and elements 19 and 25 at zero speed. This puts unit 6 also at zero speed. As illustrated by line 34, element 12 is at input speed which puts element 14 at near maximum negative speed for connected unit 5. As planetary 4 is locked up with clutch 8, element 21 is also at zero speed as shown by line 37. When the controller causes units 5 and 6 to change the ratio of the HMT and drive forward, element 25 speeds up and element 14 slows down and approaches zero as shown by line 35 at axis 14. Output 21 speeds up in a positive direction as shown by line 38. At maximum speed in mode 1, the ratios 18/28 and 22/23 are configured to have 2nd mode clutch 7 elements near synchronous speed.

As mode 2 is engaged with clutch 7, the function of planetary 4 is changed to be power splitting and thereby allow the hydrostatic units to reverse their displacements without operating in a recirculating power condition. With clutch 7 engaged, two elements each of planetary 3 and 4 are connected to each other, creating the function of a single four-element planetary but with a different ratio between the connected elements. Planetary 3 reverses direction as units 5 and 6 reverse the direction of displacement change, slowing element 25 to zero speed, and speeding up element 14 negatively. This reduces element 19 to zero speed. As element 26 is now connected to the input, element 21 increases speed as shown by line 39, raising output speed to its maximum in mode 2.

Reverse speed is obtained by engaging clutch 9 at near zero output speed which is also near synchronous speed for clutch 9. This causes element 21 to reverse as 19 increases in a positive direction. Maximum reverse speed is shown by line 40 at axis 21.

Continuous power is delivered from the engine to the wheels, with continuous ratio change, from full reverse to full forward speed even though the transmission changes modes at zero speed and between zero and maximum forward speed. For downshifts, the process is reversed. Transmission control functions may be accomplished in a manner similar to that in U.S. Pat. No. 5,560,203 or by other suitable control means. As such U.S. Pat. No. 5,560,203 is incorporated herein. Depending on the vehicle requirements, mode 2 or reverse could be eliminated by omitting either clutch 8 or clutch 9.

Alternate speed diagrams are possible to achieve the same relationship between the input 1 and output 2 speeds. For instance, element 14 could be located on the opposite side of element 12 from element 25. This would require unit 5 to start near maximum positive speed and thus reverse the sign of its displacement. The speed diagram needs only to meet the requirements for input speed vs. output speed, and to achieve the required shift points without exceeding limitations on planetary element speed, reasonable gear ratios and economy of parts. This change would leave the block diagram in FIG. 1 unchanged.

Over the range of each mode, the units 5 and 6 operate to zero speed but not through zero, meaning that neither unit operates in the negative of its starting displacement. This allows for no recirculating power in the hydrostatic transmission, lowering transmitted power and increasing efficiency. The combination of opposite displacement change for unit 5 and 6, and the lack of negative displacement for both units makes this transmission suitable for stroking the units at the same time and with the same stroking mechanism.

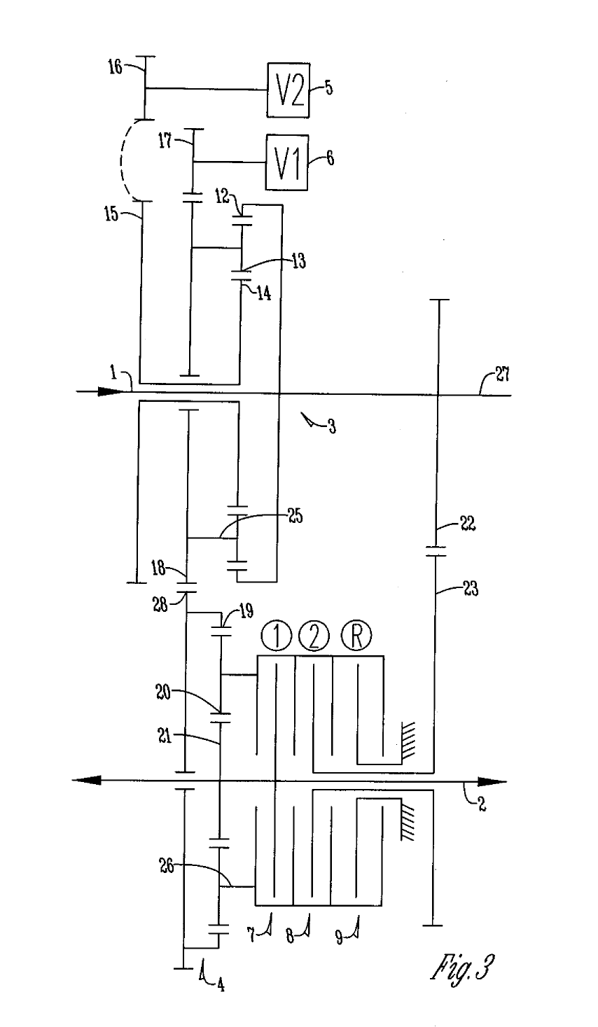

A gear and clutch schematic for the HMT of FIGS. 1 and 2 is shown in FIG. 3. Input shaft 1 is offset and parallel to output shaft 2. Planetary 3 is located on the input shaft centerline; element 12 is a ring, 14 is a sun and 25 is a carrier. Planet gears 13 complete planetary 3 gear set. For planetary 4, it is on the output centerline and has element 19 as a ring, element 21 a sun and element 26 a carrier. Planet gears 20 complete planetary 4 gear set. Unit 5 is connected to element 14 with the gear set 16/15. Unit 6 is connected to element 25 with gear set 17/18. Gear set 18/28 connects element 25 of planetary 3 and element 19 of planetary 4. Clutches 7, 8 and 9 are adjacent to each other on the same centerline as planetary 4. Element 12 is connected to clutch 8 with gear set 22/23.

This gear and clutch schematic is configured to achieve several objectives in the layout of the transmission. The input and output are on adjacent and parallel centerlines to match vehicle requirements. The input centerline and planetary 3 arrangement allows a through PTO drive 27. The output centerline, planetary 4 and clutch arrangement allows a through output shaft 2 for both front and rear drive shafts and axles. The clutches 7, 8 and 9 are adjacent to each other for ease of routing the power to apply them. The highest speed elements are sun gears 14 and 21 to minimize high speed rotating mass.

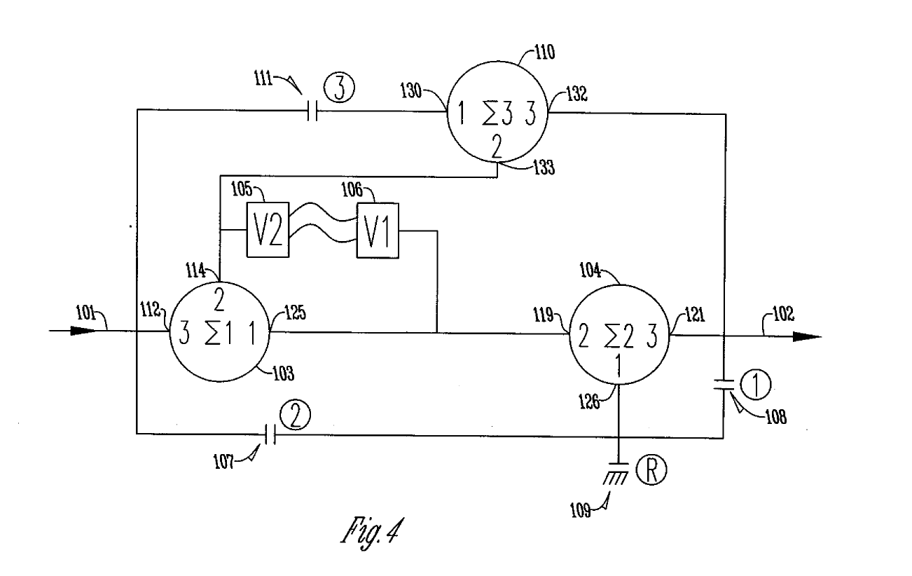

The three forward mode transmission of FIGS. 4-6 is similar to the two mode transmission of FIGS. 1-3, except that it has an additional planetary, clutch and related gears for adding the third mode. The elements of the three mode that are similar to the two mode HMT have the same number with 100 added to its value. For example, planetary 3 for the two mode is planetary 103 and element 14 is element 114 for the three mode. Descriptive material for the three mode that is the same as for the two mode is not repeated.

FIG. 4 shows a block diagram of a three forward mode HMT. Summer 110 is a gear planetary and has three elements, 132, 133 and 130. Element 133 is connected to element 114 and element 132 is connected to output 102. There is an additional third mode clutch 111 that connects element 130 to input 101. This creates a four-element planetary function with the connections to planetary 103 when clutch 111 is engaged. The planetary 110/103 is an input summer as the input 101 is not connected to either variable unit 105 or 106, and is connected to one element of summer 110.

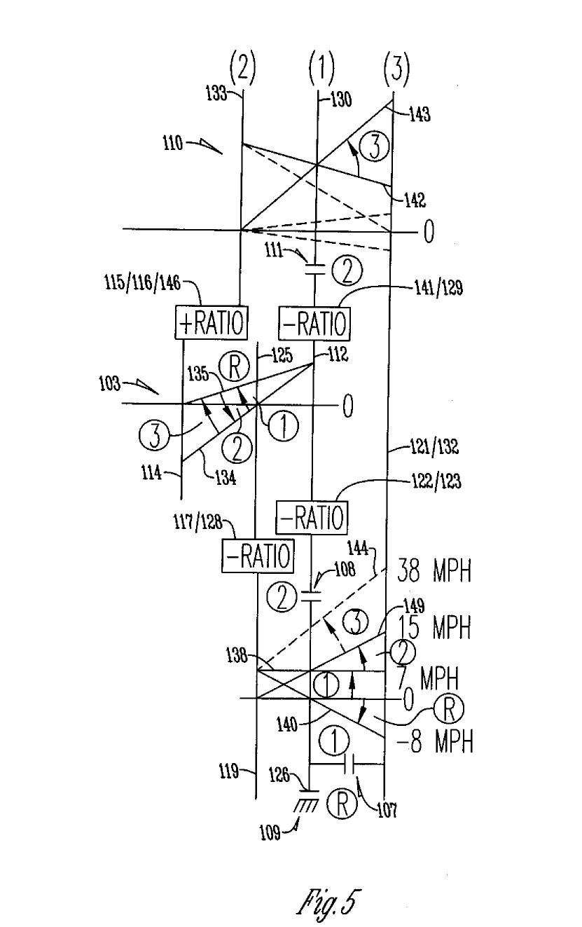

FIG. 5 is a speed diagram for planetaries 103, 104 and 105. Vertical axes 133, 130 and 132 are elements of planetary 110. There is a negative ratio 141/129 between elements 130 and 112, and a positive ratio 115/116/146 between elements 133 and 114. Elements 132 and 121 are directly connected together. Mode 1, mode 2 and reverse operate the same as for the two mode version. At maximum speed in mode 2, the ratios 141/129 and 115/116/146 are configured to have 3rd mode clutch 111 elements at near synchronous speed.

As mode 3 is engaged with clutch 111, the function of planetary 103/110 is power splitting and allows the hydrostatic units to reverse their displacements without operating in a recirculating power condition. Units 105 and 106 stroke in opposite directions and do not operate through zero speed or operate in the negative of their starting displacement. However, planetary 110 now changes speed in the same direction of element 125 as it is now connected to element 114 with positive gear ratio 115/116/146. (Note that this appears as the opposite direction in FIG. 5 because the drawing convention is to keep forward output speed always positive.) Starting from line 142, as unit 106 increases speed, unit 105 decreases speed, element 133 decreases speed raising output 132 as shown by line 143. As element 121 is connected to element 132, it also raises speed to the maximum value as shown by line 144. Continuous power is delivered from the engine to the wheels, with continuous ratio change, from full reverse to full forward speed even though the transmission changes modes at zero speed and changes twice between zero and maximum forward speed.

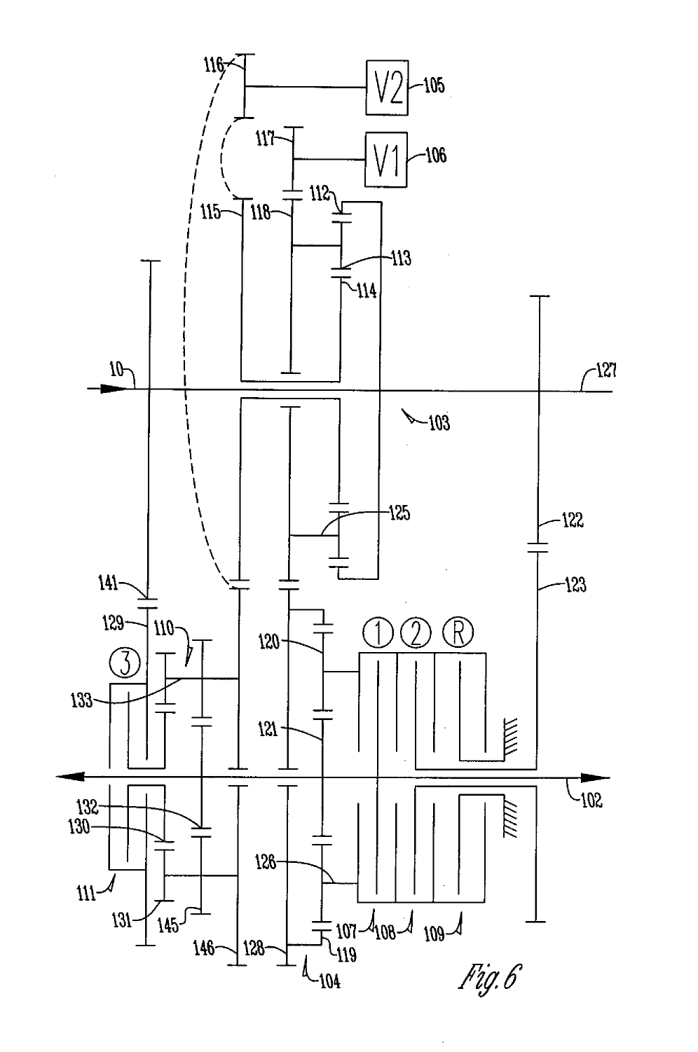

A gear and clutch schematic for the HMT of FIGS. 4 and 5 is shown in FIG. 6. For planetary 110, element 132 is a sun, 130 is also a sun and 133 is a carrier. A set of double planet gears 131/145 connect suns 130 and 132. The positive gear ratio between elements 114 and 133 is achieved with the unit 105 drive gear 116 acting as an idler between gears 115 and 146. Clutch 111 is connected with element 112 by gear set 141/129. Elements 121 and 132 are directly connected as they are on the same centerline.

It will be recognized by skilled artisans that other arrangements of planetary elements are possible which meet the requirements of FIGS. 4 and 5. For instance, element 126 could be a ring and element 119 a carrier if there were a double set of planets between the ring and sun. This change would not affect the speed diagram of FIG. 5.

This gear and clutch schematic is configured to achieve several objectives in the layout of the transmission. The input and output are on adjacent and parallel centerlines to match vehicle requirements. The input centerline arrangement allows a through PTO drive 127. The output centerline arrangement allows a through drive for both front and rear drive shafts and axles. The highest speed elements are sun gears to minimize rotating mass. The layout of the gears, clutches and hydrostatic units allows a third mode to be included as an add-on with the same basic two mode transmission.

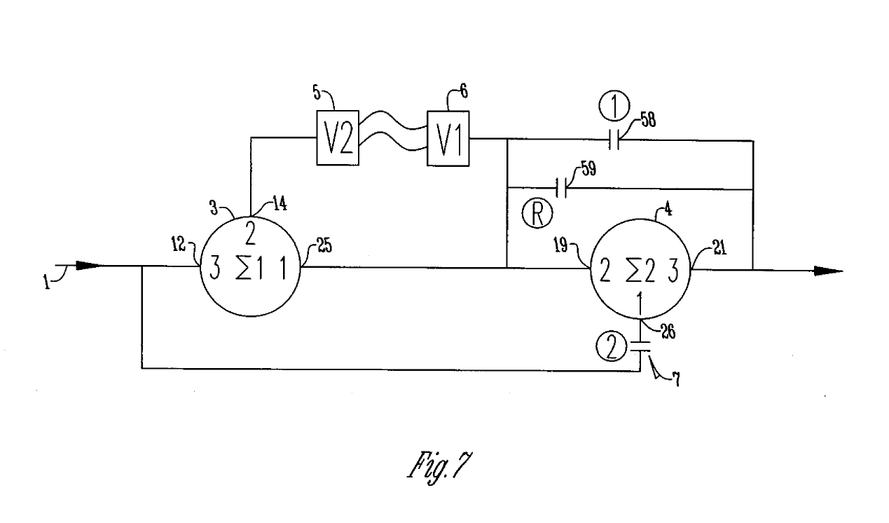

FIG. 7 shows a block diagram of an alternate two forward mode HMT. Many of the same components from the transmission of FIGS. 1, 2 and 3 and used in the same manner and have the same identification number. Summers 3 and 4 are gear planetaries and each has three elements. There are two variable displacement hydrostatic units 5 and 6. Three clutches 7, 58 and 59 vary the connections of summer 4 to summer 3. A controller regulates the displacement of units 5 and 6 and operates the clutches to achieve the desired transmission ratio and engine power delivery.

Input 1 is connected to summer element 12 of planetary 3 and output 2 is connected to element 21 of planetary 4. Unit 5 is connected to summer element 14 and unit 6 is connected elements 25 and 19. In mode 1, clutch 58 connects summer element 19 to element 21 which locks up planetary 4. In mode 2, clutch 7 connects summer element 26 to input 1, creating a four-element planetary 3/4. In reverse, element 21 is connected to element 25 which rotates element 21 in a direction opposite of element 19. Planetary 3 and 3/4 are input summers as the input 1 is not connected to either variable unit 5 or 6, and is connected to one element of summer 3.

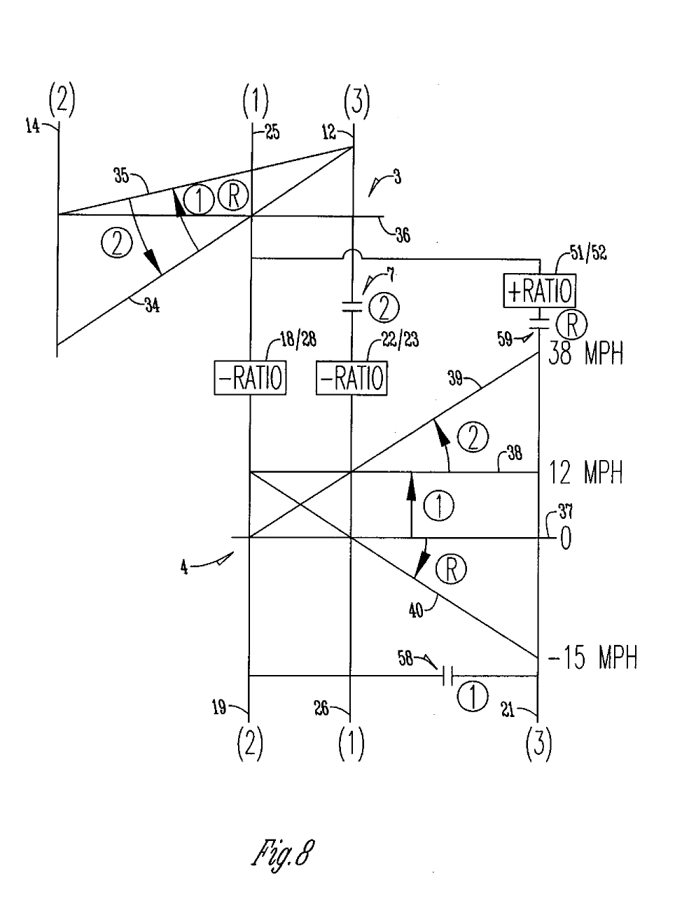

FIG. 8 is a speed diagram of the alternate two mode HMT and planetaries 3 and 4. In FIG. 8, the vertical axes 14, 25 and 12 represent speed of the elements of planetary 3 and the horizontal axis 36 is planetary ratio. Vertical axes 19, 26 and 21 are elements of planetary 4. There is a negative ratio 22/23 between elements 12 and 26 and negative ratio 18/28 between elements 25 and 19. There is a positive ratio 51/52 between elements 21 and 25. Mode 1 starts with clutch 58 engaged and elements 19 and 25 at zero speed. This puts unit 6 also at zero speed. As illustrated by line 34, element 12 is at input speed which puts element 14 at near maximum negative speed together with connected unit 5. As planetary 4 is locked up with clutch 58, element 21 is also at zero speed as shown by line 37. When the controller causes units 5 and 6 to change the ratio of the HMT and drive forward, element 25 speeds up and element 14 slows down and approaches zero as shown by line 35 at axis 14. Output 21 speeds up in a positive direction as shown by line 38. At maximum speed in mode 1, the ratios 18/28 and 22/23 are configured to have 2nd mode clutch 7 elements near synchronous speed.

As mode 2 is engaged with clutch 7, the function of planetary 4 is changed to be power splitting and thereby allow the hydrostatic units to reverse their displacements without operating in a recirculating power condition. With clutch 7 engaged, two elements each of planetary 3 and 4 are connected to each other, creating the function of a single four-element planetary but with a different ratio between the connected elements. Planetary 3 reverses direction as units 5 and 6 reverse the direction of displacement change, slowing element 25 to zero speed, and speeding up element 14 negatively. This reduces element 19 to zero speed. As element 26 is now connected to the input, element 21 increases speed as shown by line 39, raising output speed to its maximum in mode 2.

Reverse speed is obtained by engaging clutch 59 at near zero output speed which is also near synchronous speed for clutch 59. This causes element 21 to reverse as 19 increases in a positive direction. Maximum reverse speed is shown by line 40 at axis 21. Because the ratio 51/52 is selected independently, the speed of element 21 in reverse is not dependent on any of the forward speed ratios.

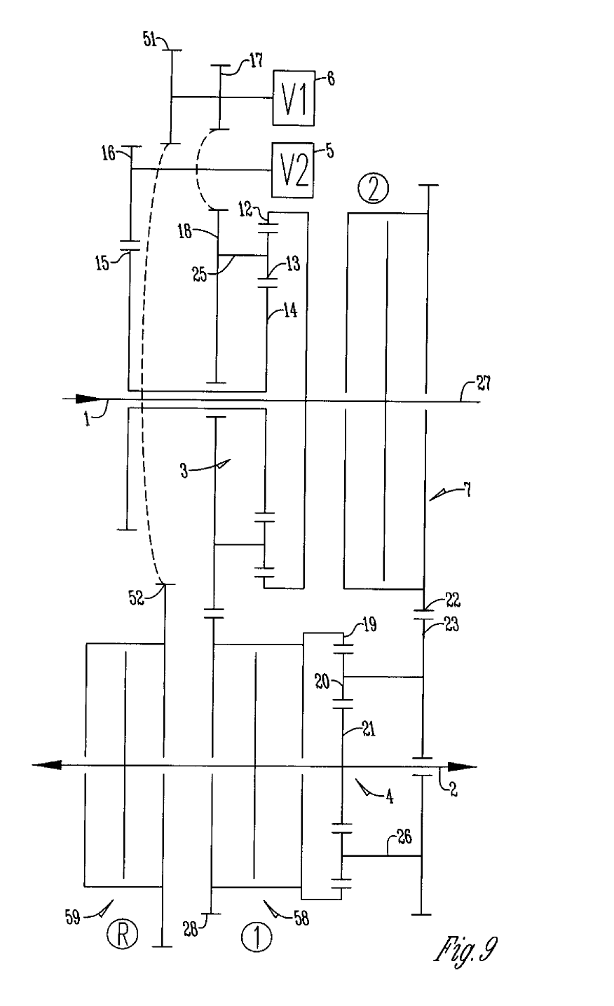

A gear and clutch schematic for the HMT of FIGS. 7 and 8 is shown in FIG. 9. Input shaft 1 is offset and parallel to output shaft 2. Planetary 3 is located on the input shaft centerline: element 12 is a ring, 14 is a sun and 25 is a carrier. Planet gears 13 complete planetary 3 gear set. Planetary 4 is on the output centerline and has element 19 as a ring, element 21 a sun and element 26 a carrier. Planet gears 20 complete planetary 4 gear set. Unit 5 is connected to sun 14 with the gear set 16/15. Unit 6 is connected to carrier 25 with gear set 17/18. Gear set 18/28 connects carrier 25 of planetary 3 and ring 19 of planetary 4. Clutches 58 and 59 are adjacent to each other on the same centerline as planetary 4. Ring 12 is directly connected to clutch 7. Gear set 51/52 connects unit 6 and sun 21 through clutch 59. Sun 21 rotates opposite of ring 19 as it is driven by three gears 17/18/28 from unit 6.

This gear and clutch schematic is configured to achieve several objectives in the layout of the transmission. The input and output are on adjacent and parallel centerlines to match vehicle requirements. The input centerline and planetary 3 arrangement allows a through PTO drive 27. The output centerline, planetary 4 and clutch arrangement allows a through output shaft 2 for both front and rear drive shafts and axles. The clutches 58 and 59 are adjacent to each other for ease of routing the power to apply them. Clutch 7 is on the input centerline to minimize clutch 7 torque and optimize the space required for the transmission. The highest speed elements are sun gears 14 and 21 to minimize high speed rotating mass.

A third mode could be added to the transmission of FIGS. 7, 8 and 9 in a manner similar to that shown in FIGS. 4, 5 and 6.

Thus, disclosed are a plurality of hydromechanical transmissions. In one embodiment a hydromechanical transmission has a first planetary having a first hydrostatic unit connected to a first element, a second hydrostatic unit connected to a second element and an input connected to a third element. In this embodiment the hydromechanical transmission additionally has a second planetary having first, second and third elements wherein a primary clutch is connected between the first and third elements of the second three-element planetary. Additionally, at least one secondary clutch is connected to the second three-element planetary wherein when the primary and secondary clutches are selectively or sequentially engaged, at least two operating modes having continuous ratios are provided.

In this embodiment of the hydromechanical transmission the second element of the second three-element planetary can be connected to the first element of the first three-element planetary. The third element of the second three-element planetary can be connected to an output. Additionally, in a preferred embodiment the input is provided with a direct drive connection from an engine without the use of a clutch. This embodiment can further comprise a third three-element planetary having a first, second and third element with the first element connected to the third element of the first three-element planetary with an auxiliary clutch and the second and third element of the third three-element planetary connected to the first element of the first three-element planetary and to an output.

In this first embodiment a second clutch can also be between a first element of the second three-element planetary and the third element of the first three-element planetary. Similarly, a reverse clutch can be connected between the first element of the second three-element planetary and a ground. Additionally, a reverse clutch can be connected between the second and third elements of the second three-element planetary. Preferably, the reverse clutch has a reversing gear between the second and third elements of the second three-element planetary.

In an alternative embodiment the hydromechanical transmission has a first three-element planetary having first, second and third elements wherein the first and second elements are connected to a hydrostatic transmission and the third element is connected to an input. Additionally, in this embodiment the second element of the first three-element planetary travels between zero speed and a high speed when the first element of the first three-element planetary travels between a maximum speed and zero speed. This embodiment additionally has a second three-element planetary having first, second and third elements wherein the second element of the second three-element planetary is connected to the first element of the first three-element planetary and the third element of the second three-element planetary is connected to an output. This embodiment also provides wherein at least two clutches are connected to the second three-element planetary and when selectively engaged at least two operating modes having a continuous ratio are provided.

In this alternative embodiment a clutch can be connected between the third element of the first three-element planetary and the first element of the second three-element planetary. Similarly, a reverse clutch can be connected between the first element of the second three-element planetary and a ground. Alternatively, a clutch can be connected between two elements of the second three-element planetary. In yet another alternative, the first element of the first three-element planetary has a negative gear ratio to the second element of the second three-element planetary and the third element of the first three-element planetary has a negative gear ratio to the first element of the second three-element planetary.

This embodiment can also further comprise a third three-element planetary having first, second and third elements wherein the third element of the third three-element planetary is connected to the third element of the second three-element planetary, a second element of the third three-element planetary is connected to the second element of the first three-element planetary and an auxiliary clutch is between the first element of the third three-element planetary and the third element of the first three-element planetary. Additionally, in this embodiment there can be a negative ratio between the first element of the third three-element planetary and the third element of the first three-element planetary and a positive ratio between the second element of the third three-element planetary and the second element of the first three-element planetary. In this alternative embodiment a reverse clutch can connect a positive ratio between the third element of the second three-element planetary and the first element of the first three-element planetary.

In yet another alternative embodiment the hydromechanical transmission can have a first three-element planetary located on an input center line and having a first, second and third elements wherein the first three-element planetary is connected to an input at the third element. This embodiment additionally has a second three-element planetary having first, second and third elements wherein the second three-element planetary is located on an output center line and is connected to an output at the third element. A hydromechanical transmission is connected to the second and third elements of the first three-element planetary and at least two clutches are connected to the second three-element planetary. Thus, the clutches can be selectively or sequentially engaged to provide at least two operating modes with a continuous ratio.

In this embodiment the hydromechanical transmission has two variable hydrostatic units wherein the first hydrostatic unit changes displacement in the opposite direction of the second hydrostatic unit in each of the operating modes. Specifically, the first and second hydrostatic units do not have the negative of a starting displacement during the entire speed range of the transmission.

Additionally, in this embodiment the second element of the second three-element planetary can be connected to the first element of the first three-element planetary. The clutches also may be adjacent to one another and the input shaft can extend through the transmission for power take off purposes. Additionally, the output shaft can extend through the transmission to provide drive at both ends of the transmission. Preferably, the highest speed elements of the first and second three-element planetaries are sun gears.

Additionally, in this embodiment, there can be three clutches wherein a first clutch is between two elements of the first three-element planetary, a second clutch is between the first element of the second three-element planetary and the third element of the first three-element planetary and a reverse clutch is connected to the second three-element planetary. Specifically, the third three-element planetary is located on the output centerline and has a third element connected to the output, a second element connected to the second element of the first three-element planetary and a first element connected to the third element of the first planetary with a fourth clutch.

It will be appreciated by those skilled in the art that other various modifications could be made to the device without the parting from the spirit in scope of this invention. All such modifications and changes fall within the scope of the claims and are intended to be covered thereby.

We claim:

1. A hydromechanical transmission comprising:
a first planetary having a first hydrostatic unit connected to a first element a second hydrostatic unit connected to a second element and an input connected to a third element;
a second planetary having first, second and third elements;
a primary clutch connected between the first and third elements of the second planetary;
at least one secondary clutch connected to the second planetary; and
wherein when the primary and secondary clutches are selectively engaged at least two operating modes having continuous ratios are provided.

2. The hydromechanical transmission of claim 1 wherein the second element of the second planetary is connected to the first element of the first planetary.

3. The hydromechanical transmission of claim 1 wherein the third element of the second planetary is connected to an output.

4. The hydromechanical transmission of claim 1 wherein the input is a direct drive connection from an engine without a clutch.

5. The hydromechanical transmission of claim 1 further comprising a third planetary having first, second and third elements with the first element connected to the third element of the first planetary with an auxiliary clutch and the second and third elements of the third planetary connected to the second element of the first planetary and to an output.

6. A hydromechanical transmission comprising:
a first planetary having first, second and third elements wherein the first and second elements are connected to a hydrostatic transmission and the third element is connected to an input;
wherein the second element of the first planetary travels between zero speed and a high speed when the first element of the first planetary travels between a maximum speed and zero speed; and
wherein at least two clutches are connected to a second planetary and when selectively engaged at least two operating modes having a continuous ratio are provided.

7. The hydromechanical transmission of claim 6 wherein a clutch is connected between the third element of the first planetary and the first element of the second planetary.

8. The hydromechanical transmission of claim 6 wherein a reverse clutch is connected between the first element of the second planetary and a ground.

9. The hydromechanical transmission of claim 6 wherein a clutch is connected between two elements of the second planetary.

10. The hydromechanical transmission of claim 6 wherein the first element of the first planetary has a negative gear ratio to the second element of the second planetary; and the third element of the first planetary has a negative gear ratio to the first element of the second planetary.

11. The hydromechanical transmission of claim 6 further comprising a third planetary having first, second and third elements; wherein the third element of the third planetary is connected to the third element of the second planetary, a second element of the third planetary is connected to the second element of the first planetary and an auxiliary clutch is between the first element of the third planetary and the third element of the first planetary.

12. The hydromechanical transmission of claim 11 wherein there is a negative ratio between the first element of the third planetary and third element of the first planetary and a positive ratio between the second element of the third planetary and the second element of the first planetary.

13. A hydromechanical transmission comprising:
A first planetary on an input centerline having first, second and third elements and connected to an input at the third element;
a second planetary on an output centerline having first, second and third elements and connected to an output at the third element;
a hydrostatic transmission connected to the second and third elements of the first planetary;
at least two clutches connected to the first element of the second planetary; and
wherein when the clutches are selectively engaged at least two operating modes with a continuous ratio are provided.

14. The hydromechanical transmission of claim 13 further comprising: first and second variable hydrostatic units; wherein the first hydrostatic unit changes displacement in the opposite direction of the second hydrostatic unit in each of the operating modes.

15. The hydromechanical transmission of claim 14 wherein the first and second hydrostatic units do not have a negative of a starting displacement during an entire speed range of the transmission.

16. The hydromechanical transmission of claim 13 wherein the second element of the second planetary is connected to the first element of the first planetary.

17. The hydromechanical transmission of claim 13 wherein the clutches are adjacent to each other.

18. The hydromechanical transmission of claim 13 wherein the input shaft extends through the transmission to provide a power take-off.

19. The hydromechanical transmission of claim 13 wherein the output shaft extends through the transmission to provide a drive at both ends of the transmission.

20. The hydromechanical transmission of claim 13 wherein at least one planetary element is a sun gear.

21. The hydromechanical transmission of claim 1 wherein a second clutch is between a first element of the second planetary and the third element of the first planetary.

22. The hydromechanical transmission of claim 1 wherein a reverse clutch is connected between the first element of the second planetary and a ground.

23. The hydromechanical transmission of claim 1 wherein a reverse clutch is connected between the second and third elements of the second planetary.

24. The hydromechanical transmission of claim 23 wherein the reverse clutch has a reversing gear between the second and third elements.

25. The hydromechanical transmission of claim 6 wherein a reverse clutch connects a positive ratio between the third element of the second planetary and the first element of the first planetary.

26. The hydromechanical transmission of claim 13 wherein there are three clutches, a first clutch is between two elements of the first planetary, a second clutch is between the first element of the second planetary and the third element of the first planetary, and a reverse clutch is connected to the second planetary.

27. The hydromechanical transmission of claim 26 wherein a third planetary is located on the output centerline and has a third element connected to the output, a second element connected to the second element of the first planetary, and a first element connected to the third element of the first planetary with a fourth clutch.
